(19) United States
(12) Patent Application Publication
(10) Pub. No.: US 2009/0022957 A1
(43) Pub. Date: Jan. 22, 2009

(54) DECORATIVE SHEET AND METHOD FOR PRODUCING THE SAME

(75) Inventors: Tsutomu Aso, Saitama (JP); Satoshi Tamura, Saitama (JP); Hiroyuki Nihashi, Tokyo (JP); Katsuhito Murata, Tokyo (JP); Takeshi Fukuda, Tokyo (JP); Shinichi Umeda, Saitama (JP)

Correspondence Address: OSHA LIANG L.L.P., TWO HOUSTON CENTER, 909 FANNIN, SUITE 3500, HOUSTON, TX, 77010, US

(73) Assignee: SHIN-ETSU POLYMER CO., LTD., Tokyo (JP)

(21) Appl. No.: 12/278,725

(22) PCT Filed: Apr. 5, 2007
(86) PCT No.: PCT/JP2007/057671

§ 371 Date: Aug. 7, 2008

(30) Foreign Application Priority Data
Apr. 6, 2006 (JP) 2006-105539

(51) Int. Cl. B32B 3/26; B29C 59/16

(52) U.S. Cl. 428/160; 264/447

(57) ABSTRACT

A decorative sheet has a structure of: a laminate sheet having a base film and a decorative layer formed on the base film; and a surface resin layer having a transparent resin layer and a printed layer formed in an image pattern on the transparent resin layer, being laminated on the laminate sheet at the decorative layer side. The surface resin layer is laminated so as the printed layer to come to the laminate sheet side, the surface of the laminate sheet at the decorative layer side forms an indented profile having concavities on the decorative layer recessed to the base film side, and the printed layer enters the concavities. The printed layer is a layer formed by printing a printing liquid containing a photocuring component containing polyurethane and polyester, a thermoplastic resin, and a solvent, in an image pattern on the transparent resin layer, and by removing the solvent from the printed printing liquid, and then by curing the photocuring component under light irradiation.

### TECHNICAL FIELD

The present invention relates to a decorative sheet and a method for manufacturing thereof, and specifically relates to a decorative sheet used for forming a molding on which surface a decorative pattern is formed, and to a method for manufacturing thereof.

### BACKGROUND ART

There are widely used moldings such as panels made of synthetic resin, on which surface a decorative pattern is formed. The decorative pattern has been shifting to have further luxurious effect, and in recent years, there are trials to give decorative patterns having a design providing three-dimensional stereoscopic effect.

As a method to provide the molding with decorative pattern, there is an available method to cover the surface of resin molding with a decorative sheet having a decorative layer, (refer to, for example, Patent Documents 1 and 2). That type of molding is obtained by, for example, a method of integral molding of a resin with a decorative sheet during the resin injection molding. Major applicable integral molding methods are in-mold molding and insert molding. According to the in-mold molding, a decorative sheet is formed to a specified shape within a mold, and in that state, a resin is injected onto the decorative sheet by injection molding. On the other hand, the insert molding is conducted by placing a decorative sheet, which is preliminarily formed, in a mold, substantially without further forming the decorative sheet in the molding, and then by injecting a resin onto the decorative sheet by injection molding.

Since the decorative sheet used in the in-mold molding is required to have formability in the mold, generally the thickness thereof is relatively small. In concrete terms, the thickness of the decorative sheet used in the in-mold molding is normally in an approximate range from 50 to 200 μm. On the other hand, the decorative sheet used in the insert molding can be the one having relatively large thickness. Specifically for the case of insert molding, the applied decorative sheet normally has a thickness in an approximate range from 0.2 to 1.0 mm. Thicker decorative sheet is easier in handling, and gives larger degree of freedom for forming.
Patent Document 1: Japanese Patent Laid-Open No. 2002-264289
Patent Document 2: Japanese Utility Model Registration No. 3015173

### DISCLOSURE OF THE INVENTION

### Problems to be Solved by the Invention

For a decorative sheet used to obtain a molding by insert molding, which molding has a base film and a decorative layer being formed on one side of the base film and has a decorative pattern, the inventors of the present invention found that the adoption of a structure composed of a transparent resin layer and a surface resin layer having a printed layer being formed in an image pattern on one side of the transparent resin layer, thus covering the decorative layer, can provide a three-dimensional stereoscopic effect.

For the case of the decorative sheet having above structure, however, it was found that the interlayer adhesion and the weatherability likely deteriorate when the printed layer faces to the decorative layer. Insufficient weatherability increases the possibility of inducing separation of the surface resin layer during long period of use of the molding. On the other hand, when the printed layer is positioned opposite to the decorative layer, or is faced outside, there arises a problem of likely inducing insufficient resistance to chemicals.

Responding to the situation, an object of the present invention is to improve the interlayer adhesion and the weatherability of the decorative sheet which can sufficiently provide three-dimensional stereoscopic effect. Another object of the present invention is to improve the resistance to chemicals of the decorative sheet which can sufficiently provide three-dimensional stereoscopic effect.

### Means to Solve the Problems

The decorative sheet according to the present invention has: laminate sheet having a base film and a decorative layer formed on the base film; and a surface resin layer having a transparent resin layer and a printed layer formed in an image pattern on the transparent resin layer, being laminated on the laminate sheet at the decorative layer side.

According to a first aspect of the present invention, the surface resin layer is laminated so as the printed layer to come to the laminate sheet side. The surface of the laminate sheet at the decorative layer side forms an intended profile having concavities on the decorative layer recessed to the base film side, and the printed layer enters the concavities. The printed layer is a layer formed by printing a printing liquid containing a photocuring component containing polyurethane and polyester, a thermoplastic resin, and a solvent, in an image pattern on the transparent resin layer, and by removing the solvent from the printed printing liquid, and then by curing the photocuring component under light irradiation.

The decorative sheet according to the first aspect of the present invention can satisfactorily provide three-dimensional stereoscopic effect, and is satisfactorily excellent in terms of interlayer adhesion and of weatherability. Since the decorative layer recesses in part to the base film side, the surface of the decorative layer generates height-differences, which height-differences allow forming the three-dimensional stereoscopic effect. To fully provide the stereoscopic effect, the recess of the decorative layer is required to increase to some extent. To do this, the printed layer is required to increase the thickness to some extent. To this point, by using a printing liquid containing a photocuring component, a thermoplastic resin, and a solvent, a printed layer having large thickness can readily be formed. Furthermore, since the photocuring component contains polyurethane and polyester, the interlayer adhesion and the weatherability are significantly improved.

According to a second aspect of the present invention, the surface resin layer in the decorative sheet of the present invention is laminated so as the printed layer to come to opposite to the laminated sheet side.

The decorative sheet according to the second aspect of the present invention can satisfactorily provide three-dimensional stereoscopic effect, and has satisfactory resistance to chemicals. Since the printed layer which positions at uppermost layer of the molding after the insert molding is formed in an image pattern, an indented profile is formed on the surface of the molding. Based on the indented profile, the stereoscopic effect including tactual sense is provided. By forming the printed layer at uppermost layer using an ink having the above specific composition, sufficient resistance to chemicals is attained.

For both structures given above, it is preferable that the decorative layer has a glossy surface. The glossy surface provides specifically good stereoscopic effect.

The method for manufacturing the decorative sheet according to the present invention has the step of thermocompressing a surface resin layer having a transparent resin layer and a printed layer formed on the transparent resin layer to a laminate sheet having a base film and a decorative layer formed on the base film, thus obtaining a decorative sheet having the laminate sheet and the surface resin layer laminated on the laminate sheet at the decorative layer side.

According to the first aspect of the present invention, the surface resin layer is thermocompressed to the laminate sheet so as the printed layer to come to the laminate sheet side. In this case, the printed layer is pressed-in the surface of the laminate sheet on thermocompressing the surface resin layer to the laminate sheet, thus forming an indented profile having concavities on the printed layer recessed to the base film side on the surface of the decorative layer side of the laminate sheet.

The manufacturing method according to the first aspect of the present invention is favorably adopted as the method of manufacturing the decorative sheet according to above first aspect of the present invention.

According to the second aspect of the present invention, the surface resin layer is thermocompressed to the laminate sheet so as the printed layer to come to opposite to the laminated sheet side. The method is favorably adopted as the method of manufacturing the decorative sheet according to above second aspect of the present invention.

Alternatively, the method of manufacturing the decorative sheet according to the present invention may contain the steps of: thermocompressing a transparent resin layer to a laminate sheet having a base film and a decorative layer formed on the base film; and forming a printed layer on the thermocompressed transparent resin layer to form a surface resin layer having the transparent resin layer and the printed layer being formed on the transparent resin layer, thus obtaining the decorative sheet having the laminate sheet and the surface resin layer being laminated thereon at the decorative layer side of the laminate sheet.

For any of above manufacturing methods, the printed layer is a layer formed by printing a printing liquid containing a photocuring component containing polyurethane and polyester, a thermoplastic resin, and a solvent, in an image pattern on the transparent resin layer, and by removing the solvent from the printed printing liquid, and then by curing the photocuring component under light irradiation.

### EFFECT OF THE INVENTION

According to the first aspect of the present invention, it is possible to improve the interlayer adhesion and the weatherability of the decorative sheet which can provide satisfactorily three-dimensional stereoscopic effect. According to the second aspect of the present invention, it is possible to improve the resistance to chemicals of the decorative sheet which can provide satisfactorily three-dimensional stereoscopic effect.

### BRIEF DESCRIPTION OF THE DRAWINGS

FIG. 1 shows an edge view of an embodiment of combined laminate sheet and surface resin layer.

FIG. 2 shows an edge view of an embodiment of decorative sheet.

FIG. 3 shows a process of method for manufacturing decorative sheet, as an embodiment.

FIG. 4 shows an edge view of another embodiment of decorative sheet.

FIG. 5 shows a single side view of further embodiment of decorative sheet.

### DESCRIPTION OF THE REFERENCE SYMBOLS

1: decorative sheet, 3: laminate sheet, 4: support film, 5: surface resin layer, 6: transfer sheet, 10: double belt press, 30: base film, 31: decorative layer, 35: concavity, 50: transparent resin layer, 51, 52: printed layer.

### BEST MODES FOR CARRYING OUT THE INVENTION

The preferred embodiments of the present invention are described below in detail. The prevent invention, however, is not limited to the embodiments.

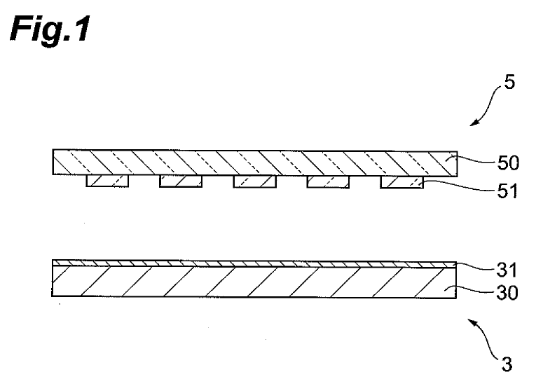

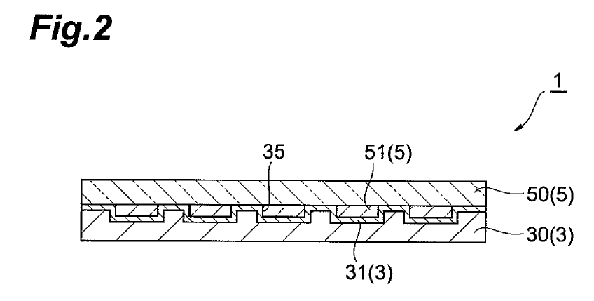

FIG. 1 shows an edge view of combined laminate sheet and surface resin layer, used for obtaining the decorative sheet. The laminate sheet 3 in FIG. 1 has a base film 30 and a decorative layer 31 being formed to cover the entire surface on one side of the base film 30. The surface resin layer 5 given in FIG. 1 has a transparent resin layer 50 and a printed layer 51 being formed in an image pattern of a periodic pattern on one surface of the transparent resin layer 50. By thermocompressing the laminate sheet 3 with the surface resin layer 5 so as the decorative layer 31 and the printed layer 51 face with each other inward, the decorative sheet 1 given in FIG. 2 is formed.

The transparent resin layer 50 which structures the surface resin layer 5 is a layer that has light-transmittance, allowing visually observing the decorative layer 31 from outside, typically a transparent resin film. The transparent resin film includes a resin film containing at least one resin selected from the group consisting of polycarbonate resin, acrylic resin, fluororesin (polyvinylidene fluoride, and the like), a mixture of acrylic resin and fluororesin, polyurethane-based resin, polyester-based resin, polyolefin-based resin, and polystyrene-based resin. As of these, acrylic resin film is preferred. The surface of resin film may be coated by a mat material, or which mat material may be kneaded into the resin film. The thickness of the transparent resin layer 50 is preferably in a range from 50 to 500 μm, and more preferably from 75 to 150 μm.

Between the transparent resin layer 50 and the printed layer 51, there may be inserted a primer layer which is prepared by coating a primer on the transparent resin layer 50. The primer contains a solvent and a resin selected from the group consisting of acrylic resin, copolymer of vinyl chloride and vinyl acetate, polyurethane resin, or a combination of them. By drying the coated primer, the primer layer is formed.

The printed layer 51 is a layer formed by printing a printing liquid containing a photocuring component, a thermoplastic resin, and a solvent, in an image pattern on the transparent resin layer 50, and by removing the solvent from the printed printing liquid, and then by curing the photocuring component under light irradiation. In other words, the printed layer 51 is composed of a photocuring component and a cured material which is formed by curing the photocuring composition that contains a thermoplastic resin. The printing liquid used to form the printed layer 51 is prepared typically by mixing an ultraviolet ray (ionized radiation ray) curing resin as the photocuring component, with a solvent-based ink containing a thermoplastic resin and a solvent. The printed layer 51 is preferably colorless and transparent. However, the printed layer 51 may be colored by a coloring matter such as pigment.

The printed layer 51 is printed in an image pattern such as dots and stripe pattern. Reflecting the pattern of the printed layer 51, an indented profile is formed on the surface of the decorative layer 31.

The photocuring component forming the printing liquid contains polyurethane and polyester, and is a component creating a cross-linked structure by polymerization under light irradiation. Normally the photocuring component contains a prepolymer which has a photo-polymerizing functional group. Polyurethane and polyester exist typically in the photocuring component as a prepolymer having a photo-polymerizing functional group. In other words, the photocuring component contains polyurethane having a photo-polymerizing functional group and polyester having a photo-polymerizing functional group.

The photo-polymerizing functional group includes radical-polymerizing unsaturated group such as (meth)acryloyloxy group and cationic polymerizing functional group such as epoxy group. The (meth)acryloyloxy group signifies acryloyloxy group and methacryloyloxy group. (Meth)acrylate and the like are also the same in meaning.

Preferable polyurethane having photo-polymerizing functional group includes urethane(meth)acrylate having two or more of (meth)acrylate group. The urethane(meth)acrylate is prepared by, for example, the reaction between a prepolymer having isocyanate group at terminal, which prepolymer is generated by a reaction between polyisocyanate and polyol, with hydroxyalkyl(meth)acrylate. The polyisocyanate used in the reaction includes aromatic diisocyanate such as 2,4-tolylene diisocyanate, xylene diisocyanate, and diphenylmethane-4,4′-diisocyanate, and aliphatic or alicyclic isocyanate such as 1,6-hexamethylene diisocyanate, isophorone diisocyanate, and hydrogenated tolylene diisocyanate. The polyol includes acrylic polyol, polyester polyol, polycarbonate polyol, polyether polyol, and polyurethane polyol. The weight average molecular weight of urethane(meth)acrylate is preferably in a range from 250 to 100,000.

A preferred polyester having photo-polymerizing functional group is polyester (meth)acrylate having two or more of (meth)acylate group. Examples of the polyester (meth)acrylate are the ones introducing (meth)acrylate group into a polyester obtained from dicarboxylic acid selected from the group consisting of phthalic anhydride, isophthalic acid, terephthalic acid, succinic anhydride, adipic acid, azelaic acid, sebacic acid, tetrahydro phthalic anhydride, hexahydro phthalic anhydride, tetrabromo phthalic anhydride, tetrachloro phthalic anhydride, Het anhydride, himic anhydride, maleic anhydride, fumaric acid, itaconic acid, and trimelitic anhydride, and from diol selected from the group consisting of ethylene glycol, propylene glycol, 1,3-butylene glycol, 1,6-hexane diol, diethylene glycol, dipropylene glycol, cyclohexanon-1,2-diol, cyclohexane dimethanol, glycerin, trimethylol ethane, and trimethylol propane.

The weight average molecular weight of polyester (meth)acrylate is preferably in a range from 250 to 10,000, and more preferably from 500 to 10,000.

The above weight average molecular weight relating to urethane (meth)acrylate and polyester (meth)acrylate is the standard polystyrene converted value determined by the Gel Permiation Chromatography (GPC).

In the photocuring component, the ratio of the polyester to the polyurethane [polyester/polyurethane] is preferably in a range from 90/10 to 5/95 by mass to their sum of 100, and more preferably [polyester/polyurethane] is in a range from 60/40 to 10/90. Within the above range of [polyester/polyurethane], balance of adhesion and weatherability is achieved at a specifically high level.

Other than above polyurethane and polyester, the photocuring component may further contain a photo-polymerizing monomer or prepolymer within a range not to deteriorate the essence of the present invention. Applicable photo-polymerizing monomer includes monofunctional (meth)acrylate such as methyl(meth)acrylate, 2-ethylhexyl(meth)acrylate, and phenoxyethyl(meth)acrylate, and polyfunctional (meth)acrylate such as diethyleneglycol di(meth)acrylate, propyleneglycol di(meth)acrylate, trimethylolpropane tri(meth)acrylate, trimethylolpropane ethylene oxide tri(meth)acrylate, dipentaerythritol tetra(meth)acrylate, and dipentaerythritol hexa(meth)acrylate. Photo-polymerizing prepolymer includes epoxy (meth)acrylate, melamine (meth)acrylate, triazine (meth)acrylate, and silicone (meth)acrylate.

The printing liquid normally contains a photo-polymerization initiator. The photo-polymerization initiator is adequately selected from the normally used ones. For the case that the photo-polymerizing functional group is a radical polymerizing unsaturated group, applicable photo-polymerization initiator includes acetophenones, benzophenones, thioxanthones, benzoin, and benzoin methylethers. When the photo-polymerizing functional group is a cationic polymerizing functional group, applicable photo-polymerization initiator includes aromatic diazonium salt, aromatic sulfonium salt, aromatic iodonium salt, metallocene compound, and benzoin sulfonic acid ester. Those compounds are used separately or in combination of two or more of them. The adding amount of the photo-polymerization initiator is about 0.1 to about 10 parts by mass to 100 parts by mass of the photocuring component.

Applicable thermoplastic resin forming the printing liquid can be selected from normally used thermoplastic resins forming solvent-based inks. Examples of the thermoplastic resin are acrylic resin, copolymer of vinyl chloride and vinyl acetate, chlorinated polyolefin (chlorinated polyethylene, chlorinated polypropylene, and the like), polyester, polyurethane generated from polyisocyanate and polyol, vinyl acetate, vinyl chloride, and cellulose-based resin. They are used separately or in combination of two or more of them. As of these, preferred ones are acrylic resin and copolymer of vinyl chloride and vinyl acetate.

A preferable content of the thermoplastic resin is in a range from 1 to 75% by mass to the sum of photocuring component and thermoplastic resin, and more preferably from 3 to 25% by mass. Within the range of the content of thermoplastic resin, the balance of adhesion and weatherability is attained at a specifically high level. When the content of thermoplastic resin increases, the thickness-increase in the printed layer 51 tends to become difficult.

The solvent adopts the one which can dissolve or disperse the thermoplastic resin therein. Preferable solvent includes ester such as ethyl acetate, ether such as diethyl ether, ketone such as methylethyl ketone, aromatic hydrocarbon such as toluene, and alcohol such as methanol. The content of solvent is normally in a range from about 30 to about 90% by mass to the sum of thermoplastic resin and solvent.

When the printing liquid is prepared by mixing a ultraviolet-curing resin with a solvent-based ink containing a thermoplastic resin and a solvent, the mixing ratio (mass ratio) of the ultraviolet-curing resin to the solvent-based ink, [ultraviolet-curing resin/solvent-based ink] is preferably from 95/5 to 10/90, and more preferably from 90/10 to 50/50.

The glass transition temperature of the printed layer 51 is preferably 75° C. or above. The determination of glass transition temperature of the printed layer 51 is done by TMA which measures the temperature changes of specimen, as a dynamic characteristic, or by DSC (differential scanning calorimetry) (JIS K-7121) which measures absorbed heat and generated heat under varied temperature of specimen. The thickness of the printed layer 51 is preferably in a range from 5 to 20 μm, and more preferably from 8 to 15 μm. By assuring the glass transition temperature of the printed layer 51 to 75° C. or above and/or by assuring the thickness thereof within the above range, further sharp stereoscopic effect can be attained.

Printing the printing liquid on the transparent resin layer 50 is done by adequately selecting one of normally adopted printing methods. Specifically the printing liquid is preferably printed by screen printing. Screen printing easily increases the thickness of the printed layer 51. Increase in the thickness of the printed layer 51 can provide her clear stereoscopic effect. The flat bed screen printing and the continuous screen printing are specifically preferred from the point of obtaining high production efficiency.

Removal of solvent from the printing liquid is preferably done with heating the printing liquid. Applicable heating means include hot air and infrared light. The solvent is not necessarily completely removed, and there is allowable remained solvent at an amount which allows the printed layer to be normally formed after the photocuring.

After removing (drying) the solvent, typically ultraviolet ray is irradiated to cure the photocuring component. Normally the ultraviolet ray in wavelengths from 190 to 380 nm is irradiated. Applicable light source of ultraviolet ray includes ultrahigh pressure mercury lamp, high pressure mercury lamp, low pressure mercury lamp, carbon arc lamp, black light, and metal halide lamp. The solvent may be removed after curing the photocuring component by irradiating ultraviolet ray.

The base film 30 adopts resin film. Preferable resin film includes the one containing at least one resin selected from the group consisting of polyolefin, polyester, polycarbonate, polystyrene, AS (copolymer of acrylonitrile and styrene) resin, ABS (copolymer of acrylonitrile, butadiene, and styrene) resin, and polyvinyl chloride. Applicable polyolefin includes a high crystalline polyolefin such as low density or high density polyethylene, polypropylene, polymethyl pentene, polybutene, copolymer of ethylene and propylene, and copolymer of propylene and butene, an olefin-based thermoplastic elastomer. As of these, ABS resin film is preferred.

The base film 30 may contain a coloring agent. Addition of coloring agent hides the color of resin molding being formed inside the decorative sheet 1, and adjusts the color of the base film 30 as the base color of the decorative layer 31.

The base film 30 may further contain, at need, various additives such as fire-retardant, lubricant, anti-oxidant, ultraviolet absorber, light-stabilizer, and filler. Applicable fire-retardant includes aluminum hydroxide and magnesium hydroxide. Applicable ultraviolet absorber includes benzotriazole and a derivative thereof, benzophenone and a derivative thereof. Applicable light-stabilizer includes hindered amine-based radical trapping agent. Applicable filler includes mica, talc, calcium carbonate, barium sulfate, silica, alumina, and kaolinite.

The base film 30 may be a composite film composed of pluralities of layers. For example, when the base film 30 is composed of two sheets of resin films, these resin films may be directly fused with each other, or may be laminated together inserting an adhesive layer therebetween. A suitable method to thermally fuse directly two sheets of resin films is the co-extrusion method using a T-die. The adhesive layer is, for example, formed by two-liquid type polyurethane. On using the adhesive layer, the two sheets of resin films are adhered by, for example, the dry-lamination method.

The decorative layer 31 is a layer provided with a desired design in a shape, pattern, color, or combination of them. The decorative layer 31 has a pattern such as wood grain pattern, stone grain pattern, cloth texture pattern, leather figures pattern, geometrical figure, character, symbol, and solid pattern. As shown in FIG. 1, the decorative layer may be formed covering entire surface of the base film, or alternatively, it may be formed in an image pattern with the desired pattern.

The decorative layer 31 preferably has a glossy surface. Specifically the surface gloss value of the decorative layer 31 is preferably 95 or higher, and more preferably 100 or higher. That high surface gloss value allows providing specifically high stereoscopic effect. The gloss value is the one determined by a gloss meter set at 60° under the condition specified by MS K7105. Although the upper limit of the gloss value is not specifically specified, normally about 200 is applied. A decorative layer having high gloss value can be formed by, for example, a metallic ink containing metal particles.

The decorative layer 31 is formed by a method in which ink is printed on the base film 30. Applicable printing method includes gravure printing, offset printing, silk screen printing, and transfer from a transfer sheet. In particular, it is preferred to transfer the decorative layer 31 formed, in advance, by gravure printing on a separate support film, onto the base film 30.

The ink generally contains pigment or dye, vehicle, solvent, and assistant. The ink may further contain metal particles. Applicable vehicle includes chlorinated polyolefin such as chlorinated polyethylene and chlorinated polypropylene, polyester, polyurethane prepared from polyisocyanate and polyol, acrylic resin, vinyl acetate, vinyl chloride, copolymer of vinyl chloride and vinyl acetate, cellulose-based resin, and polyamide resin. They are used separately or in combination of two or more of them. As of these, preferable vehicles from the point to apply light load to environment are at least one resin selected from the group consisting of polyester, polyurethane, acrylic resin, vinyl acetate, cellulose-based resin, and polyamide resin.

FIG. 2 shows an edge view of an embodiment of decorative sheet. The decorative sheet 1 shown in FIG. 2 has a structure of laminating the laminate sheet 3 and the surface decorative resin layer 5 given in FIG. 1. According to the decorative sheet 1 in FIG. 2, the surface resin layer 5 is laminated on the laminate sheet 3 so as the printed layer 51 to come to the laminate sheet 3 side. The surface of the decorative layer 31 of the laminate sheet 3 has a periodically indented profile having concavities 35 on the decorative layer 31 recessed to the base film 30 side, which concavities 30 are filled with the printed layer 51. Based on the indented profile, the visual stereoscopic effect viewed from the surface resin layer 5 side is created. The decorative sheet 1 can form an excellent decorative design providing clear stereoscopic effect.

The thickness of the entire decorative sheet 1 is preferably in a range from 0.2 to 1.0 mm. The decorative sheet having that specified thickness gives large degree of freedom on determining the conditions for molding and forming, provides excellent durability to varieties of working and handling, and is specifically suitable for insert molding.

For example, the decorative sheet 1 is prepared by the steps of: printing the above printing liquid in an image pattern on the transparent resin layer 50, and removing the solvent from the printed printing liquid, then by curing the photocuring component under the light irradiation, thus forming the printed layer 51; and thermocompressing the surface resin layer 5 to the laminate sheet 3, thus obtaining the decorative sheet having the laminate sheet 3 and the surface resin layer 5 being laminated to the laminate sheet 3 at the decorative layer 31 side. The printed layer 51 is formed by the above-described method. The surface resin layer 5 is thermocompressed to the laminate sheet 3 so as the printed layer 51 to come to the laminate sheet 3 side.

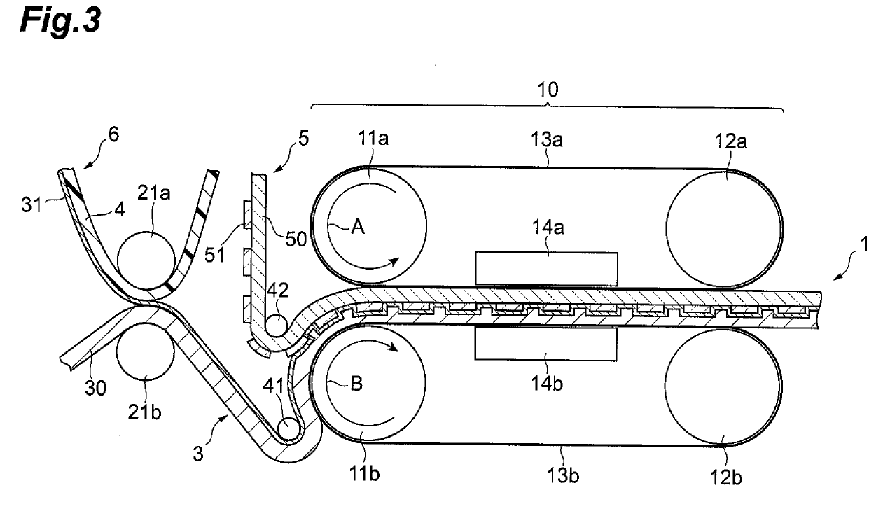

FIG. 3 is a schematic drawing of the process of method for manufacturing decorative sheet, as an embodiment. According to the embodiment given in FIG. 3, firstly a transfer sheet 6 having a support film 4 and the decorative layer 31 formed on the support film 4, and the film base 30 are supplied to sandwiching thereof between a rubber roll 21a and a hot roll 21b, thus thermocompressing theretogether. After that, the support film 4 is peeled off, thus letting the decorative layer 31 transfer from the support film 4 to the base film 30, thereby obtaining the laminate sheet 3 having the base film 30 and the decorative layer 31.

After the transfer, the laminate sheet 3 is not coiled, and a separately supplied surface resin layer 5 is continuously thermocompressed to the surface of the laminate sheet 3 at the decorative layer 31 side using a double belt press 10. The long decorative sheet 1 is continuously supplied to the downstream side of the double belt press 10.

The double belt press 10 is structured mainly by a pair of endless belts 13a and 13b positioned facing each other, first rolls 11a and 11b which heat the endless belts 13a and 13b, respectively, and second rolls 12a and 12b which cool the endless belts 13a and 13b, respectively. The endless belt 13a runs between the first roll 11a and the second roll 12b, and the endless belt 13b runs between the first roll lib and the second roll 12b. The endless belts 13a and 13b are the ones having mirror finish surface, such as steel endless belts.

The endless belts 13a and 13b are driven by the rotation of the first roll and the second roll so as to run from the first rolls 11a and 11b to the second rolls 12a and 12b at the belt planes facing thereeach. Consequently, the first roll 11a rotates in the arrow A direction (anticlockwise in the figure), and the second roll 11b rotates in the arrow B direction (clockwise in the figure). Between the first roll 11a and the second roll 12a, there is positioned a pressing part 14a at a position close to the inner peripheral surface of the endless belt 13a to press the laminate sheet 13 and the surface resin layer 5, which travel between the facing endless belts. Furthermore, between the first roll 11b and the second roll 12b, there is positioned a pressing part 14b at a position close to the inner peripheral surface of the endless belt 13b, which faces the pressing part 14a.

When the laminate sheet 3 travels along the outer peripheral surface of a guide roll 41 located close to the first roll 11b, and when the laminate sheet 3 is pressed by the guide roll 41, the base film 30 is introduced onto the outer peripheral surface of the endless belt 13b which runs along the outer peripheral surface of the first roll 11b so as the base film 30 to be compression bonded to the endless belt 13b. The laminate sheet 3 travels toward the facing planes of the pair of endless belts 13a and 13b driven by the rotation of the endless belt 13b. Then, the laminate sheet 3 runs over the outer peripheral surface of the guide roll 42 which is positioned on the surface of the decorative layer 31 side of the laminate sheet 3, close to the first roll 11b, and the laminate sheet 3 is pressed by the guide roll 42, thereby the surface resin layer 5 is supplied so as to be compression bonded to the laminate sheet 3 on the first roll 11b.

The laminate sheet 3 and the surface resin layer 5 positioned on the surface of the decorative layer 31 of the laminate sheet 3 are inserted between the facing planes of the pair of endless belts 13a and 13b. At that moment, it is preferable that the laminate sheet 3 and the surface resin layer 5 are inserted in a compression bonded state so as not to catch air therebetween.

The obtained decorative sheet 1 is suitably used to obtain molding products such as panel having a resin molding and the decorative sheet 1 covering a part or entire surface of the resin molding. That kind of molding products are formed preferably by the insert molding which injects a molten resin onto the surface of the base film 30 side of the decorative sheet 1 placed in the mold using injection molding. The resin molding in which the surface is decorated by the decorative sheet 1 is not specifically limited, and an injection-molding of ABS resin is an example. For the case of decorative sheet according to the embodiment of the present invention, since a decorative pattern providing the surface thereof with stereoscopic effect is formed in advance, a molding product having less-irregularity and stable decorative pattern is readily obtained.

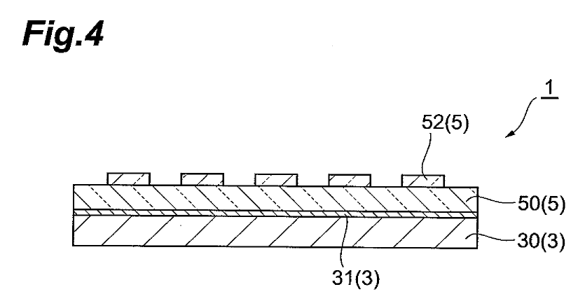

FIG. 4 shows an edge view of another embodiment of decorative sheet. Also the decorative sheet 1 of FIG. 4 has the structure of laminated laminate sheet 3 and surface resin layer 5 in FIG. 1. According to the decorative sheet 1 in FIG. 4, the surface resin layer 5 is laminated on the laminate sheet 3 so as the printed layer 52 to come to opposite to the laminate sheet 3 side. The printed layer 52 is in a protruding state, thereby creating three-dimensional stereoscopic effect based on thus formed protruded profile. For the embodiment of FIG. 4, it is possible to provide stereoscopic effect by tactual sense as well as visual sense. For the case of printed layer 52 positioned on the surface, the thickness thereof is preferably 8 μm or more to obtain good stereoscopic effect. The thickness of the printed layer 52 is preferably 60 μm or less.

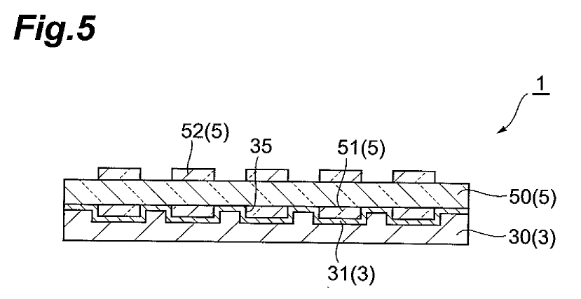

Instead of the flat pattern on the surface of the laminate sheet at the decorative layer side, as in the case of FIG. 4, the surface of the laminate sheet at the decorative layer side may have, as shown in FIG. 5, an indented profile having concavities on the decorative layer recessed to the base film side. In that case, for example, a part or entire of the printed layer is pressed-in the transparent resin layer, and the transparent resin layer deformed by entering the printed layer forms an indented profile on the surface of the laminate sheet at the decorative layer side.

The decorative sheet 1 in FIG. 4 is obtained by, for example, thermocompressing the surface resin layer 5 to the laminate sheet 3 so as the printed layer 52 to come to opposite to the laminate sheet 3 side. In this case, preferably the thermal compression bonding is conducted in a state that a cover film is placed at the surface resin layer 5 side. With the procedure, the printed layer 52 easily maintains the protruded state even after the thermal compression bonding. Applicable cover film is, for example, a non-oriented polypropylene film. Alternatively, after the step of thermocompressing the transparent resin layer 5 to the laminate sheet, the printed layer 52 may be formed on the transparent resin layer 5.

### EXAMPLES

The present invention is described below in more detail referring to the examples. The present invention, however, is not limited to the examples.

### Manufacture Example 1

### Specification of Internal Screen Printing

A UV-curing ink and a solvent-based ink were mixed at the respective ratios given in Table 1, thus prepared the respective printing liquids (screen inks) containing a photocuring component, a thermoplastic resin, and a solvent. The ratio given in Table 1 is expressed by weight ratio in the weight including the solvent.

The applied UV-curing ink was the one composed of urethane acrylate and polyester acrylate, and 1-hydroxy-cyclohexyl-phenylketone as the photo-polymerization initiator. The urethane acrylate was the one obtained from 2,4-tolylene diisocyanate and polyester polyol. The weight average molecular weight of the urethane acrylate was 15,000. The polyester acrylate was the one prepared from tetrahydrophthalic anhydride and 1,6-hexane diol. The weight average molecular weight of the polyester acrylate was 3,000. The urethane acrylate and the polyester acrylate were mixed at a specific ratio (mass ratio) given in Table 1.

The solvent-based ink applied was the one prepared by dissolving acrylic resin and copolymer of vinyl chloride and vinyl acetate, or sole copolymer of vinyl chloride and vinyl acetate, in cyclohexanone. The ratio of the resin component was 31% by mass to the total weight of the solvent-based ink.

On a long acrylic resin film (thickness of 75μ, EBS-010, manufactured by Mitsubishi Rayon Co., Ltd.), the respective screen inks given in Table 1 were printed in dot pattern (1.0 mm in diameter and 1.0 mm in spacing) using a continuous screen printer. The line speed was 10 m/min. After printing, the solvent was removed from the ink by letting the acrylic resin film pass through a hot-air furnace (hot air and IR, 80° C.), and then NV irradiation (6 kW) was applied to cure the ink. After that, the laminate as the surface resin layer having the acrylic film on which the dot pattern printed layer was formed was coiled.

Both a transfer film composed of a PET film on which entire one side surface thereof was covered with a decorative layer which was formed by gravure-printing a high brightness ink (gloss value of 110), and an ABS sheet (thickness of 450 μm, 975BK1, manufactured by Shin-Etsu Chemical Co., Ltd.), were sandwiched between a metal roll (170° C. of roll temperature) and a rubber roll, thus letting them pass between the rolls to continuously peel the PET film, thereby continuously transferred the decorative layer from the PET film to the ABS sheet. After that, using a double belt press (180° C. of head temperature and 5 m/min of line speed), the laminate sheet, in which the decorative layer was formed on the ABS sheet as the base film, and the surface resin layer were laminated together so as the decorative layer and the printed layer face inward each other, and then they were integrated together by thermal compression bonding, thereby obtained the decorative sheet. The process from the transfer of the decorative layer to the formation of decorative sheet was continuously conducted using an apparatus having similar structure to that of the manufacturing apparatus of FIG. 3.

Using specimens cut in a specified size from the obtained decorative sheet, the initial adhesion and the adhesion after the weathering test were evaluated. The evaluation of adhesion was given by the method using cross-cut tape specified in JIS K5400 (2001). The weathering test was conducted by placing the specimen on a back plate, and light of 150 MJ of Xenon lamp was irradiated to the specimen while heating the back plate to 89° C.

TABLE 1

| | Screen ink | | | | | Adhesion | |
|---|---|---|---|---|---|---|---|
| | UV-curing | | | | | | After |
| | ink/Solvent- | | | Specification of | Coating thickness | | weather- |
| No. | based ink* (Wet) | UV-curing ink | Solvent-based ink | screen bed | (Dry) [μm] | Initial stage | ring test |
| Example 1 | 8/2 | Polyurethane/ | Acrylic resin and | 165 mesh/ | 10 | 0/100 | 0/100 |
| | | Polyester = 5/1 | copolymer of vinyl | 21% opening | | | |
| | | | chloride and vinyl | percentage | | | |
| | | | acetate | | | | |
| Example 2 | 8/2 | Polyurethane/ | Acrylic resin and | 165 mesh/ | 10 | 0/100 | 0/100 |
| | | Polyester = 2/1 | copolymer of vinyl | 21% opening | | | |
| | | | chloride and vinyl | percentage | | | |
| | | | acetate | | | | |
| Example 3 | 5/5 | Polyurethane/ | Copolymer of vinyl | 130 mesh/ | 15 | 0/100 | 0/100 |
| | | Polyester = 2/1 | chloride and vinyl | 33% opening | | | |
| | | | acetate | percentage | | | |
| Comparative | 8/2 | Only | Acrylic resin and | 165 mesh/ | 10 | 0/100 | 70/100 |
| Example 1 | | Polyurethane | copolymer of vinyl | 21% opening | | | |
| | | | chloride and vinyl | percentage | | | |
| | | | acetate | | | | |
| Comparative | 10/0 | Only | — | 195 mesh/ | 10 | 0/100 | 95/100 |
| Example 2 | | Polyurethane | | 18% opening | | | |
| | | | | percentage | | | |
| Comparative | 0/10 | — | Acrylic resin and | 130 mesh/ | 2 | 0/100 | 0/100 |
| Example 3 | | | copolymer of vinyl | 33% opening | | | |
| | | | chloride and vinyl | percentage | | | |
| | | | acetate | | | | |

*Mass ratio after drying (removing solvent); 8/2 corresponds to 9.3/0.7, and 5/5 corresponds to 7.7/2.3

The result is given in Table 1. For the Examples using both the UV-curing ink which contains polyurethane acrylate and polyester acrylate, and the solvent-based ink, both the initial adhesion and the adhesion after the weathering test gave satisfactorily excellent values. To the contrary, Comparative Examples 1 and 2, which used the U-curing ink which did not contain polyester acrylate, gave significantly deteriorated adhesion after the weathering test, though the initial adhesion was excellent. For Comparative Example 3 which used sole solvent-based ink as the screen ink, the coating thickness could not become thick, and the visual stereoscopic effect of the formed design was insufficient.

### Manufacture Example 2

### Specification of Internal Screen Printing

Using flat bed silk screen printing, the screen ink having the respective compositions given in Table 1 was continuously screen-printed on the acrylic resin film. Thus printed ink was dried by hot air at 80° C. Then, UV irradiation (3.6 kW) was applied to cure the ink, thus obtained a laminate of the acrylic resin film and the surface resin layer formed thereon as the printed layer having dot pattern. The screen bed applied was: 420 mesh/inch and 30 μm of wire thickness for Examples 1 and 2 and Comparative Example 1; 330 mesh/inch and 30 μm of wire thickness for Example 3 and Comparative Example 3; and 460 mesh/inch and 30 μm of wire thickness for Comparative Example 2. The respective decorative sheets were prepared by similar procedure to that of Manufacture Example 1 except for using the above laminate. Evaluation was given to the prepared decorative sheets in terms of initial adhesion and adhesion after the weathering test, which evaluation showed similar trend to that of Manufacture Example 1.

### Manufacture Example 3

### Specification of Internal Screen Printing

The decorative sheet was prepared by the similar procedure to that of Manufacture Example 1 except for adopting the method of thermal lamination sandwiching the materials between a metal roll (180° C. of roll temperature) and a rubber roll, instead of using the method applying double belt press. Evaluation was given to the prepared decorative sheets in terms of initial adhesion and adhesion after the weathering test, which evaluation showed similar trend to that of Manufacture Example 1.

### Manufacture Example 4

### Specification of Surface Screen Printing

On a long acrylic resin film (thickness of 125 μm, SO14, manufactured by Sumitomo Chemical Co., Ltd.), the respective screen inks given in Table 2 were printed in dot pattern (1.0 mm in diameter and 1.0 mm in spacing) using a continuous screen printer. The line speed was 15 m/min. After printing, the solvent was removed from the ink by letting the acrylic resin film pass through a hot-air furnace (hot air and IR, 80° C.), and then UV irradiation (3.6 kW) was applied to cure the ink. After that, printed film in which the dot pattern printed layer was formed on the acrylic resin film was coiled. The screen ink applied was the same to that in Manufacture Example 1 except for the compositions given in Table 2.

Both a transfer film composed of a PET film on which entire one side surface thereof was covered with a decorative layer which was formed by gravure-printing a high brightness ink (gloss value of 100), and an ABS sheet (thickness of 450 μm, 975BK1, manufactured by Shin-Etsu Chemical Co., Ltd.), were sandwiched between a metal roll (170° C. of roll temperature) and a rubber roll, thus letting them pass between the rolls to continuously peel the PET film, thereby continuously transferred the decorative layer from the PET film to the ABS sheet.

After that, the laminate sheet having the decorative layer formed on the ABS sheet, and the surface resin layer were laminated each other so as the decorative layer to come to inward and the printed layer to come to outward, and then further a CPP cover film was placed on the printed layer. In that state, they were inserted into a double belt press (180° C. of head temperature and 5 m/min of line speed) to obtain the decorative sheet which integrated the surface resin layer with the laminate sheet. The decorative sheet was coiled while peeling the non-oriented polypropylene (CPP) film. The process from the transfer of the decorative layer to the formation of decorative sheet was continuously conducted using an apparatus having similar structure to that of the manufacturing apparatus of FIG. 3.

Using specimens cut in a specified size from the obtained decorative sheet, the initial adhesion and the adhesion after the weathering test were evaluated by the same procedure to that of Manufacture Example 1. The evaluation of adhesion was given by the method using cross-cut tape specified in JIS K5400.

TABLE 2

| | Screen ink | | | | | | Adhesion | |
|---|---|---|---|---|---|---|---|---|
| | UV-curing | | | | | | | After |
| | ink/Solvent | | | | Specification of | Coating thickness | | weather- |
| No. | based ink* (Wet) | UV-curing ink | Solvent-based ink | Coloring | screen bed | (Dry) [μm] | Initial stage | ing test |
| Example 4 | 8/2 | Polyurethane/ | Acrylic resin and | None | 165 mesh/21% | 10 | 0/100 | 0/100 |
| | | Polyester = 1/1 | copolymer of vinyl | (transparent) | opening | | | |
| | | | chloride and vinyl | | percentage | | | |
| | | | acetate | | | | | |
| Example 5 | 8/2 | Polyurethane/ | Acrylic resin and | Gray | 130 mesh/33% | 25 | 0/100 | 0/100 |
| | | Polyester = 1/1 | copolymer of vinyl | | opening | | | |
| | | | chloride and vinyl | | percentage | | | |
| | | | acetate | | | | | |
| Example 6 | 5/5 | Polyurethane/ | Copolymer of vinyl | None | 130 mesh/33% | 15 | 0/100 | 0/100 |
| | | Polyester = 1/1 | chloride and vinyl | (transparent) | opening | | | |
| | | | acetate | | percentage | | | |
| Example 7 | 8/2 | Polyurethane/ | Acrylic resin and | None | 130 mesh/33% | 25 | 0/100 | 0/100 |
| | | Polyester = 1/1 | copolymer of vinyl | (transparent) | opening | | | |
| | | | chloride and vinyl | | percentage | | | |
| | | | acetate | | | | | |
| Comparative | 8/2 | Only | Copolymer of vinyl | None | 165 mesh/21% | 10 | 0/100 | 0/100 |
| Example 4 | | Polyurethane | chloride and vinyl | (transparent) | opening | | | |
| | | | acetate | | percentage | | | |
| Comparative | 8/2 | Only | Acrylic resin | None | 165 mesh/21% | 10 | 0/100 | 0/100 |
| Example 5 | | Polyurethane | | (transparent) | opening | | | |
| | | | | | percentage | | | |

*Mass ratio after drying (removing solvent); 8/2 corresponds to 9.3/0.7, and 5/5 corresponds to 7.7/2.3.

Furthermore, to a cylinder having 40 mm of inner diameter placed on the surface of the surface resin layer of the decorative sheet, a fragrance (trade name of POPPY) by a quantity of 5 mL was poured. In that state, they were allowed to standing in a windless oven at 55° C. for 4 hours. Then, the resistance to chemicals was evaluated based on the appearance of the surface resin layer at the position contacted the fragrance. Separately, to a cylinder having 40 mm of inner diameter placed on the surface of the surface resin layer of the decorative sheet, a plasticizer (DOP, phthalic acid ester) by a quantity of 5 mL was poured. In that state, they were allowed to standing in a windless oven at 80° C. for 72 hours. Then, the resistance to chemicals was evaluated based on the appearance of the surface resin layer at the position contacted the plasticizer. The decorative sheet was evaluated also in terms of stereoscopic effect and of tactual sense. In the table, the excellence of stereoscopic effect and of tactual sense are given by the decreasing order of A, B, and C. Regarding the evaluation of tactual sense, when direct touch by hand gave adequate feeling of surface roughness, the evaluation was given as “preferable”, and when the touch gave excessive roughness or gave non-roughness, the evaluation was given as “poor”. The evaluation result is given in Table 3.

TABLE 3

| | Screen ink | | | | | | | |
|---|---|---|---|---|---|---|---|---|
| | UV-curing | | | | | | Resistance to | |
| | ink/Solvent | | | | Stereoscopic | | chemicals | |
| No. | based ink (Wet) | UV-curing ink | Solvent-based ink | Coloring | effect | Tactual sense | Fragrance | Plasticizer |
| Example 4 | 8/2 | Polyurethane/ | Acrylic resin and | None | B | B | Non- | Non- |
| | | Polyester = 1/1 | copolymer of vinyl | (transparent) | | | abnormality | abnormality |
| | | | chloride and vinyl | | | | | |
| | | | acetate | | | | | |
| Example 5 | 8/2 | Polyurethane/ | Acrylic resin and | Gray | C | A | Non- | Non- |
| | | Polyester = 1/1 | copolymer of vinyl | | | | abnormality | abnormality |
| | | | chloride and vinyl | | | | | |
| | | | acetate | | | | | |
| Example 6 | 5/5 | Polyurethane/ | Copolymer of vinyl | None | B | B | Non- | Non- |
| | | Polyester = 1/1 | chloride and vinyl | (transparent) | | | abnormality | abnormality |
| | | | acetate | | | | | |
| Example 7 | 8/2 | Polyurethane/ | Acrylic resin and | None | A | A | Non- | Non- |
| | | Polyester = 1/1 | copolymer of vinyl | (transparent) | | | abnormality | abnormality |
| | | | chloride and vinyl | | | | | |
| | | | acetate | | | | | |
| Comparative | 8/2 | Only | Copolymer of vinyl | None | B | B | Whitening, | Non- |
| Example 4 | | Polyurethane | chloride and vinyl | (transparent) | | | peeling | abnormaHty |
| | | | acetate | | | | | |
| Comparative | 8/2 | Only | Acrylic resin | None | B | B | Whitening, | Non- |
| Example 5 | | Polyurethane | | (transparent) | | | peeling | abnormality |

As shown in Table 2, all the tested decorative sheets showed excellent initial adhesion and adhesion after the weathering test. As seen in Table 3, the decorative sheets gave good result at least one of stereoscopic effect and tactual sense. For Comparative Examples 4 and 5, which used UV-curing ink containing only polyurethane acrylate as the photocuring component, the resistance to fragrance was not satisfactory, and a problem was arisen in terms of resistance to chemicals.

### Manufacture Example 5

### Specification of Surface Screen Printing

The decorative sheet was prepared by the same procedure to that of Manufacture Example 4 except that an acrylic resin film not forming the printed layer thereon was laminated with a laminate sheet by a double belt press without using the CPP film, and then a screen ink was printed on the surface of the acrylic resin film by continuous screen printing. Thus obtained decorative sheet was evaluated in terms of initial adhesion and adhesion after the weathering test. The result gave similar trend to that of Manufacture Example 4.

### Manufacture Example 6

### Specification of Surface Screen Printing

The decorative sheet was prepared by the similar procedure to that of Manufacture Example 1 except for adopting the method of thermal lamination sandwiching the materials between a metal roll (180° C. of roll temperature) and a rubber roll, instead of using the method applying the double belt press. Evaluation was given to the prepared decorative sheets in terms of initial adhesion and adhesion after the weathering test, which evaluation showed similar trend to that of Manufacture Example 1.

### Manufacture Example 7

### Specification of Surface Screen Printing

The decorative sheet was prepared by the similar procedure to that of Manufacture Example 5 except that the printed layer was printed by the flat bed silk screen printing instead of the continuous screen printing. The screen bed applied was: 420 mesh/inch and 30 μm of wire thickness for Example 4 and Comparative Examples 4 and 5; and 330 mesh/inch and 30 μm of wire thickness for Examples 5, 6, and 7. Evaluation was given to the prepared decorative sheets in terms of initial adhesion and adhesion after the weathering test, which evaluation showed similar trend to that of Manufacture Example 4.

### INDUSTRIAL APPLICABILITY

The decorative sheet according to the present invention is used for decorating the surface of resin molding. According to the present invention, molding products providing three-dimensional stereoscopic effect can be manufactured in a large quantity at high production efficiency and at relatively low cost. The decorative sheet according to the present invention is applicable in wide industrial fields that desire high grade design. Specifically, the decorative sheet according to the present invention is suitably used for molding products structuring exterior panels of vehicle, ship, and aircraft, structuring building materials, household electric appliances, furniture, wall paper, Buddhist altar, Buddhist altar articles, door plate, container, clothing, bag, telephone card, bank credit card, IC card, and the like.

1. A decorative sheet comprising:
a laminate sheet having a base film and a decorative layer formed on the base film; and
a surface resin layer having a transparent resin layer and a printed layer formed in an image pattern on the transparent resin layer, being laminated on the laminate sheet at the decorative layer side, wherein
the surface resin layer is laminated so as the printed layer to come to the laminate sheet side, the surface of the laminate sheet at the decorative layer side forms an indented profile having concavities on the decorative layer recessed to the base film side, the printed layer enters the concavities, and
the printed layer is a layer formed by printing a printing liquid containing a photocuring component containing polyurethane and polyester, a thermoplastic resin, and a solvent, in an image pattern on the transparent resin layer, and by removing the solvent from the printed printing liquid, and then by curing the photocuring component under light irradiation.

2. A decorative sheet comprising:
a laminate sheet having a base film and a decorative layer formed on the base film; and
a surface resin layer having a transparent resin layer and a printed layer formed in an image pattern on the transparent resin layer, being laminated on the laminate sheet at the decorative layer side, wherein
the surface resin layer is laminated so as the printed layer to come to opposite to the laminate sheet side, and
the printed layer is a layer formed by printing a printing liquid containing a photocuring component containing polyurethane and polyester, a thermoplastic resin, and a solvent, in an image pattern on the transparent resin layer, and by removing the solvent from the printed printing liquid, and then by curing the photocuring component under light irradiation.

3. The decorative sheet according to claim 1, wherein the decorative layer has a glossy surface.

4. A method for manufacturing decorative sheet comprising the step of thermocompressing a surface resin layer having a transparent resin layer and a printed layer formed on the transparent resin layer to a laminate sheet having a base film and a decorative layer formed on the base film, thus obtaining a decorative sheet having the laminate sheet and the surface resin layer laminated on the laminate sheet at the decorative layer side, wherein
the surface resin layer is thermocompressed to the laminate sheet so as the printed layer to come to the laminate sheet side, and
the printed layer is pressed-in the surface of the laminate sheet on thermocompressing the surface resin layer to the laminate sheet, thus forming an indented profile having concavities on the decorative layer recessed to the base film side on the surface of the decorative layer side of the laminate sheet, and
the printed layer is a layer formed by printing a printing liquid containing a photocuring component containing polyurethane and polyester, a thermoplastic resin, and a solvent, in an image pattern on the transparent resin layer, and by removing the solvent from the printed printing liquid, and then by curing the photocuring component under light irradiation.

5. A method for manufacturing decorative sheet comprising the step of thermocompressing a surface resin layer having a transparent resin layer and a printed layer formed on the transparent resin layer to a laminate sheet having a base film and a decorative layer formed on the base film, thus obtaining a decorative sheet having the laminate sheet and the surface resin layer laminated on the laminate sheet at the decorative layer side, wherein
the surface resin layer is thermocompressed to the laminate sheet so as the printed layer to come to opposite to the laminate sheet side, and
the printed layer is a layer formed by printing a printing liquid containing a photocuring component containing polyurethane and polyester, a thermoplastic resin, and a solvent, in an image pattern on the transparent resin layer, and by removing the solvent from the printed printing liquid, and then by curing the photocuring component under light irradiation.

6. A method for manufacturing decorative sheet comprising the steps of:
thermocompressing a transparent resin layer to a laminate sheet having a base film and a decorative layer formed on the base film; and
printing a printing liquid containing a photocuring component containing polyurethane and polyester, a thermoplastic resin, and a solvent, in an image pattern on the thermocompressed transparent resin layer, and removing the solvent from the printed printing liquid, and then by curing the photocuring component under light irradiation, thus forming a printed layer to form a surface resin layer having the transparent resin layer and the printed layer formed on the transparent resin layer, thereby obtaining the decorative sheet having the laminate sheet and the surface resin layer laminated at the decorative layer side of the laminate sheet.

7. The decorative sheet according to claim 2, wherein the decorative layer has a glossy surface.
